(19) United States
(12) Patent Application Publication
(10) Pub. No.: US 2006/0186086 A1
(43) Pub. Date: Aug. 24, 2006

(54) Composition for forming a polymer layer and method of forming a pattern using the same

(76) Inventors: Myungsun Kim, Daegu (KR); Sangwoong Yoon, Seoul (KR); Tae-Young Kim, Seoul (KR); Young-Ho Kim, Gyeonggi-do (KR); Seok-Bong Park, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/353,628

(22) Filed: Feb. 13, 2006

(30) Foreign Application Priority Data
Feb. 24, 2005 (KR) 2005-15332

(51) Int. Cl. C23F 1/00; C08F 8/42; B05D 5/00; C08K 3/02; B05D 1/32

(52) U.S. Cl. 216/41; 525/342; 524/80; 427/282

(57) ABSTRACT

A composition for forming a polymer layer and a method of forming a pattern using the same are provided. The composition comprises a polyhydroxystyrene resin, a cross-linking compound including silicon and a solvent. The composition has an organic-inorganic hybrid system. Thus, a polymer layer formed using the composition has improved etching resistance with respect to a photoresist pattern in an etching process.

### CROSS REFERENCE TO RELATED APPLICATION

This application claims priority under 35 U.S.C. § 119 to Korean Patent Application No. 2005-15332 filed on Feb. 24, 2005, the contents of which are herein incorporated by references in their entirety.

### BACKGROUND OF THE INVENTION

1. Field of the Invention

Embodiments of the present invention relate to compositions for forming a polymer layer and methods of forming a pattern using the same.

2. Description of the Related Art

Recently, as information technology such as a computer is spread rapidly, semiconductor devices have been developed swiftly. Semiconductor devices having high integration degree and rapid response speed are desired in functional aspects. Hence, the technology of manufacturing the semiconductor devices has been developed to improve integration degree, reliability and response speed of the semiconductor devices. Particularly, the requirements for a microprocessing technology such as a photolithography process have become strict.

In order for patterns to have a line width of less than about 100 nm, a photoresist pattern formed by a photolithography process using an ArF light source is used. However, when the photoresist pattern is used as an etching mask for etching a lower layer, the photoresist pattern has a weak etching resistance. Therefore, an amorphous carbon layer (ACL) is further formed in order to compensate for the reduced etching resistance. An amorphous carbon layer is used as the etching mask with the photoresist pattern in an etching process of the lower layer.

However, the amorphous carbon layer increases the thickness of the lower layer formed. The amorphous carbon layer is formed by an additional deposition process, thereby increasing the number of processing steps. In addition, the amorphous carbon layer and the photoresist pattern both include carbon. Thus, the amorphous carbon layer is removed with respect to the photoresist pattern in an etching process using oxygen plasma. Furthermore, since the amorphous carbon layer is formed by a deposition process, undesirable particles are generated in that deposition process so that defects to the semiconductor device can occur. Additionally, the need for new equipment increases manufacturing expenses.

Therefore, a composition is still needed for forming a layer by a coating process, which generating substantially no particles during formation, and serves as an anti-reflection layer or a hardmask layer.

### SUMMARY OF THE INVENTION

Embodiments of the present invention provide a composition for forming a polymer layer having improved etching resistance. Embodiments of the present invention also provide a method of forming a pattern using the above composition.

The method of forming a pattern comprises forming a polymer layer on an object by coating thereon a composition. Then, a photoresist pattern is formed on the polymer layer, a polymer layer pattern is formed by etching an exposed polymer layer through the photoresist pattern, and an exposed object is etched using the polymer layer pattern as a mask. The method may further include removing a remaining photoresist pattern from the polymer layer pattern after etching the exposed object.

The composition includes a polyhydroxystyrene resin, a cross-linking compound including silicon and a solvent. The polyhydroxystyrene resin may have a weight average molecular weight of from about 6,500 up to about 9,500.

The cross-linking compound includes polyethyleneoxide linked with bis-trimethoxysilane. The cross-linking compound is represented by the following formula (1):

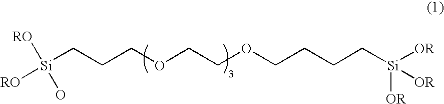

wherein R represents hydrogen or an alkyl group.

The polymer layer may include a compound represented by the following formula (2).

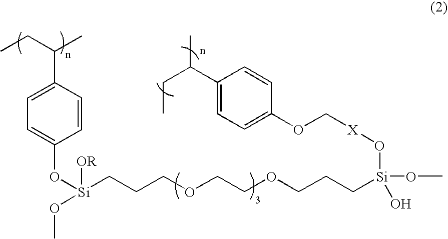

wherein R represents hydrogen or an alkyl group, X represents a chromophore and n represents an integer greater than or equal to 1.

The composition includes from about 1 up to about 6 percent by weight of the polyhydroxystyrene resin, from about 0.1 up to about 1.8 percent by weight of the cross-linking compound and a remainder of the solvent. The composition includes from about 10 up to about 35 parts by weight of the cross-linking compound based on about 100 parts by weight of the polyhydroxystyrene resin.

The polymer layer is formed by a condensation reaction between the cross-linking compound and the polyhydroxystyrene resin. The polymer layer pattern is formed by an etching process using an etching gas including oxygen (O₂) gas. Furthermore, the polymer layer is formed by a spin-coating process. The object includes silicon oxide or silicon nitride.

In an etching process using oxygen plasma, the polymer layer may have improved etching resistance with respect to a photoresist pattern. In addition, the polymer layer may have a high etching selectivity with respect to the photoresist pattern in the etching process using a fluorocarbon gas.

### BRIEF DESCRIPTION OF THE DRAWINGS

The above and other features and advantages of the present invention will become more apparent by describing in detailed example embodiments thereof with reference to the accompanying drawings, in which:

FIGS. 1 to 4 are cross-sectional views illustrating a method of forming a pattern using a composition in accordance with an embodiment of the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Composition for Forming a Polymer Layer

A composition of the present invention includes a polyhydroxystyrene (PHS) resin, a cross-linking compound including silicon and a solvent.

The polyhydroxystyrene resin is used to form a film having an anti-reflection characteristic. When the composition includes less than 1 percent by weight of the polyhydroxystyrene resin, forming the polymer layer may be difficult. In addition, when the composition includes more than 6 percent by weight of the polyhydroxystyrene resin, a polymer layer having a uniform thickness may be not formed. Thus, the composition of the present invention may preferably include from about 1 up to about 6 percent by weight of the polyhydroxystyrene resin. Particularly, when the polymer layer is formed for forming a pattern having a fine line width of less than 80 nm, the composition may more preferably include from about 2 up to about 5 percent by weight of the polyhydroxystyrene resin.

The polyhydroxystyrene resin may have a weight average molecular weight of from about 6,500 up to about 9,500, more preferably from about 7,500 up to about 8,500.

The composition includes a cross-linking compound including silicon. The cross-linking compound may be used for forming the polymer layer by performing a condensation reaction with a hydroxyl group (OH) included in the polyhydroxystyrene resin.

The cross-linking compound includes an alkoxy group. The alkoxy group may undergo a condensation reaction with the hydroxyl group (OH) included in the polyhydroxystyrene resin. Thus, the cross-linking compound is bonded with the polyhydroxystyrene resin to form the polymer layer. The polymer layer includes an inorganic compound including silicon, and an organic compound including carbon, so that the polymer layer includes an organic-inorganic hybrid system.

The cross-linking compound is represented by the following formula (1):

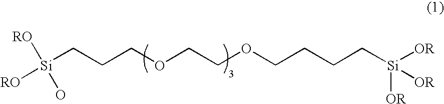

wherein R represents hydrogen or an alkyl group.

For example, the cross-linking compound includes polyethyleneoxide linked with bis-trimethoxysilane.

One example of the synthesis of the cross-linking compound is disclosed in Preparation and Characterization of Porus Organosilicate Films via Organic-Inorganic Hybrid System by Sun-Young Yoon, Seoul National University, Graduate School, 2002.

When the composition includes less than about 0.1 percent by weight of the cross-linking compound, an amount of silicon in the polymer layer may be reduced so that an etching selectivity between the polymer layer and a photoresist pattern may be reduced. When the composition includes more than about 1.8 percent by weight of the cross-linking compound, the amount of silicon in polymer layer may increase excessively so that the adhesion characteristics between the polymer layer and the photoresist pattern may be deteriorated. Then, the photoresist pattern may collapse due to such deteriorated adhesion. Thus, the composition of the present invention may preferably include from about 0.1 up to about 1.8 percent by weight of the cross-linking compound. Particularly, when the polymer layer is formed for forming a pattern having a fine line width of less than 80 nm, the composition may more preferably include from about 0.1 up to about 1.0 percent by weight of the cross-linking compound.

Additionally, the composition may preferably include from about 10 up to about 30 parts by weight of the cross-linking compound based on about 100 parts by weight of the polyhydroxystyrene resin, more preferably from about 10 up to about 20 parts by weight.

Examples of the solvent may include ethylene glycol monomethyl ether, ethylene glycol monoethyl ether, propylene glycol methyl ether, methylcellosolve acetate, ethylcellosolve acetate, diethylene glycol monomethyl ether, diethylene glycol monoethyl ether, propylene glycol methyl ether acetate, propylene glycol propyl ether acetate, diethylene glycol dimethyl ether, ethyl lactate, toluene, xylene, methyl ethyl ketone, cyclohexanone, 2-heptanone, 3-heptanone, 4-heptanone, etc. These can be used alone or in a combination thereof.

The amount of solvent may be changed according to a thickness of the polymer layer that is formed on a substrate. When the polymer layer of a higher thickness is formed, the viscosity of the composition may increase so that the amount of the solvent may be reduced. When the polymer layer having a lesser thickness is formed, the viscosity of the composition may be reduced so that the amount of the solvent may increase.

The composition may further include a catalyst as an additive. The catalyst may serve to increase a rate of the condensation reaction between the polyhydroxystyrene resin and the cross-linking compound.

The composition may further include a chromophore having an alkoxy group. The chromophore may serve to absorb light in the polymer layer formed using the composition.

The alkoxy group in the chromophore may undergo a condensation reaction with the hydroxyl group in the polyhydroxystyrene resin so that the polymer layer formed using the composition including the chromophore that may serve to absorb light. Thus, the polymer layer may serve as an anti-reflection layer.

In one embodiment of the present invention, the chromophore may include a compound having a higher absorbance that has alkoxy groups at both ends of the compound. The compound having the higher absorbance may include an aromatic group such as phenyl group and the like.

The polymer layer formed using the composition of the present invention has an organic-inorganic hybrid system and includes a compound represented by the following formula (2):

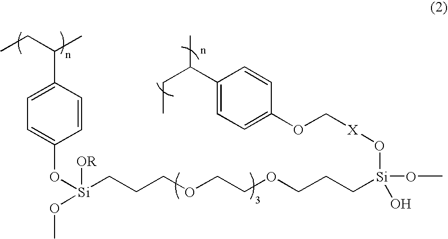

wherein R represents hydrogen or an alkyl group, X represents the chromophore and n represents an integer greater than or equal to 1.

In one embodiment of the present invention, the polymer layer may be formed by a spin-coating process.

In an etching process using oxygen plasma, the polymer layer may have an improved etching resistance with respect to a photoresist pattern. In addition, when an etching gas including fluorocarbon is used in the etching process, the polymer layer may have the improved etching resistance with respect to the photoresist pattern.

Forming a Pattern

FIGS. 1 to 4 are cross-sectional views illustrating a method of forming a pattern using a composition in accordance with one example embodiment of the present invention.

Referring to FIG. 1, an object is prepared. For example, a thin film 102 formed in a substrate 100 is used as the object. A surface treatment process may be performed for the thin film 102 to remove a contaminant remaining on the thin film 102. The thin film 102 may include a silicon nitride or a silicon oxide.

A composition is coated onto a surface of the thin film 102. The composition may be coated by a spin-coating process. The composition includes a polyhydroxystyrene resin, a cross-linking compound having silicon and a solvent.

A polymer layer 104 is formed on the thin film 102 by baking the composition. The polymer layer 104 includes the polyhydroxystyrene resin linked with the cross-linking compound. The composition may be baked at a temperature of from about 190° C. up to about 250° C., preferably from about 200° C. up to about 230° C.

The polymer layer 104 has an organic-inorganic hybrid system. In addition, the polymer layer 104 may serve as an anti-reflection layer and/or a mask layer.

For example, the polymer layer 104 includes an inorganic compound having silicon and an organic compound having carbon. The polymer layer 104 may be formed by a spin-coating process.

In an etching process using oxygen plasma, the polymer layer may have an improved etching resistance with respect to a photoresist pattern. In addition, when an etching gas including fluorocarbon is used in the etching process, the polymer layer may have the improved etching resistance with respect to the photoresist pattern.

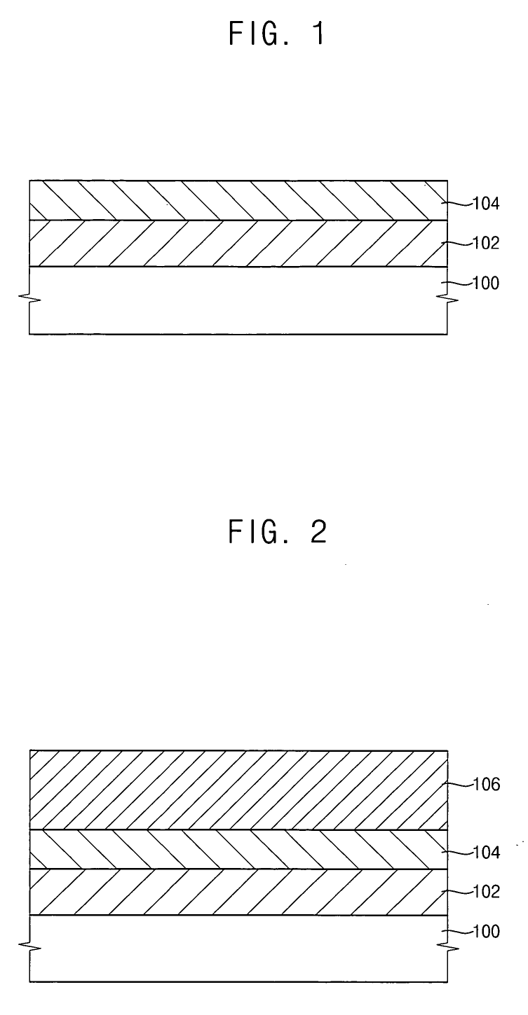

Referring to FIG. 2, a photoresist film 106 is formed on the polymer layer 104 by coating a photoresist composition.

A first baking process may be performed for the substrate 100 including the photoresist film 106 thereon. The first baking process may be performed at a temperature of from about 90° C. up to about 120° C. The first baking process may enhance an adhesive property between the polymer layer 104 and the photoresist film 106.

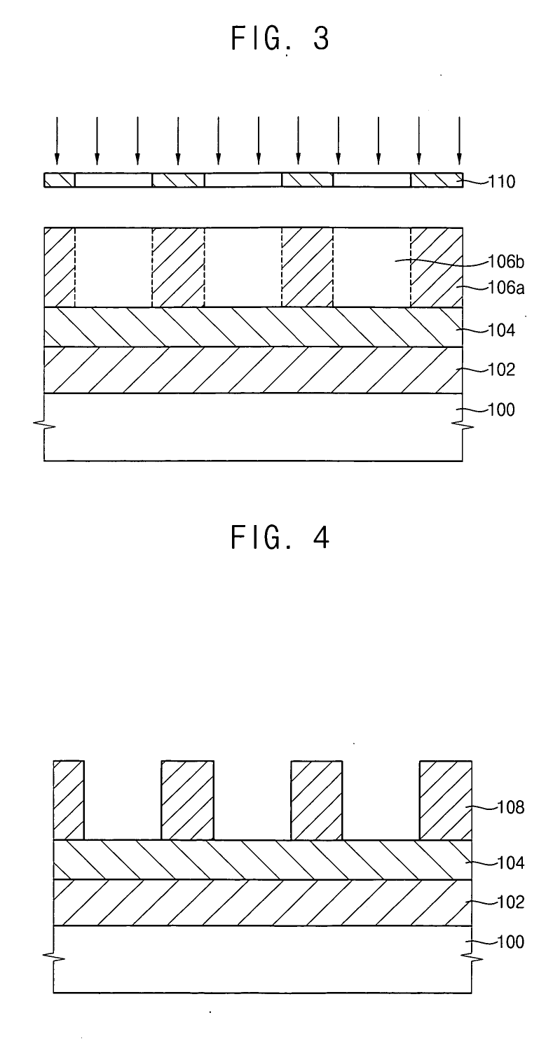

Referring to FIG. 3, the photoresist film 106 is exposed to light. For example, a mask 110 on which a predetermined pattern is formed is positioned on a mask stage of an exposure apparatus. The mask 110 is arranged over the substrate 100 having the photoresist film 106 in an alignment process. Light is irradiated onto the mask 110 for a desirable time so that a portion of the photoresist film 106 may be reacted with light through the mask 110. Light may include a laser of krypton fluoride (KrF) having a wavelength of about 248 nm, a laser of argon fluoride (ArF) having the wavelength of about 193 nm, etc.

An exposed portion 106b of the photoresist film 106 may have more hydrophilic property with respect to an unexposed portion 106a of the photoresist film 106. Thus, the unexposed portion 106a and the exposed portion 106b of the photoresist film 106 may have different solubility.

A second baking process may be performed for the substrate 100. The second baking process may be performed at a temperature of from about 90° C. up to about 120° C. The exposed portion 106b may be readily dissolved in a particular solvent by the second baking process.

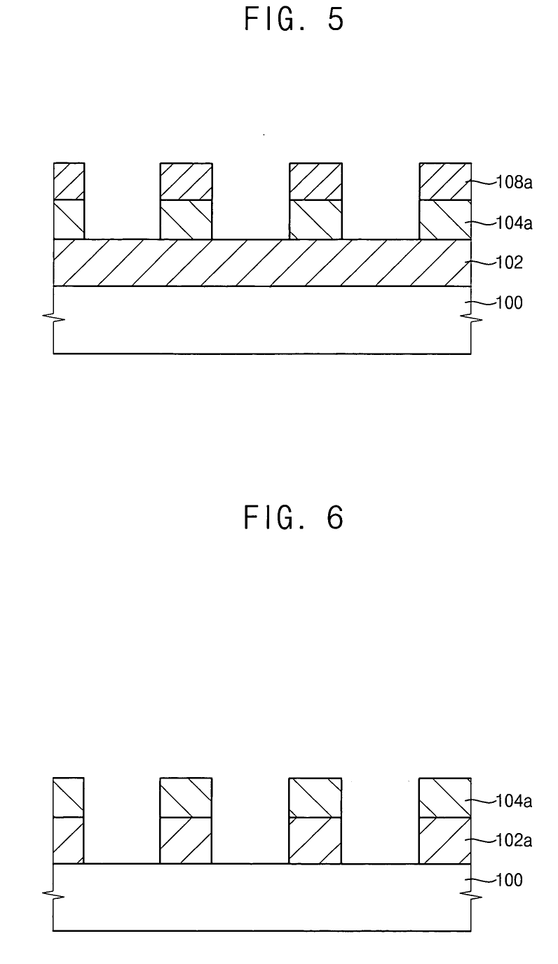

Referring to FIG. 4, the exposed portion 106b of the photoresist film 106 is dissolved using a developing solution and removed to form a photoresist pattern 108. For example, the exposed portion 106b is dissolved using the developing solution such as tetra-methyl ammonium hydroxide (TMAH), etc.

Referring to FIG. 5, a polymer layer pattern 104a is formed by etching an exposed polymer layer 104 using the photoresist pattern 108 as an etching mask. An etching process for the exposed polymer layer 104 may be performed by a dry-etching process using an etching gas including an oxygen (O₂) gas. Then, the photoresist pattern 108 has a weak etching resistance for the etching gas, so that an upper portion of the photoresist pattern 108 may be removed in the etching process for forming the polymer layer pattern 104a. Hence, a portion 108a of the photoresist pattern 108 remains.

Referring to FIG. 6, a thin film pattern 102a is formed by etching the thin film 102 using the remaining portion 108a of photoresist pattern 108 and the polymer layer pattern 104a as an etching mask.

The composition of the present invention will be further described through Examples, hereinafter.

Preparation of the Composition

### EXAMPLE 1

A composition was prepared by mixing about 3 percent by weight of a polyhydroxystyrene resin, about 0.3 percent by weight of a cross-linking compound including polyethyleneoxide linked with bis-trimethoxysilane and about 96.7 percent by weight of a solvent.

### EXAMPLE 2

A composition was prepared by mixing about 4 percent by weight of a polyhydroxystyrene resin, about 0.6 percent by weight of a cross-linking compound including polyethyleneoxide linked with bis-trimethoxysilane and about 95.4 percent by weight of a solvent.

Evaluation of a Pattern Formed Using Example 1

A substrate including a silicon nitride layer thereon was prepared. A polymer layer having a thickness of about 1,000 Å was formed on the substrate by coating a composition prepared in Example 1. A photoresist pattern having a thickness of about 1,500 Å was formed on the polymer layer. A polymer layer pattern was formed by etching an exposed polymer layer through the photoresist pattern. A silicon nitride layer pattern was formed by etching an exposed silicon nitride layer through the polymer layer pattern. When an etching gas including fluorocarbon was used in a dry-etching process for forming the silicon nitride layer pattern, the polymer layer pattern had a high etching selectivity with respect to the photoresist pattern. Thus, in a formation of the silicon nitride layer pattern, the polymer layer pattern was not removed completely, so that damage to an upper portion of the silicon nitride layer pattern was prevented.

Evaluation of a Pattern Formed Using Example 2

A substrate including a silicon oxide layer thereon was prepared. A polymer layer having a thickness of about 1,000 Å was formed on the substrate by coating a composition prepared in Example 2. A photoresist pattern having a thickness of about 1,500 Å was formed on the polymer layer. A polymer layer pattern was formed by etching an exposed polymer layer through the photoresist pattern. A silicon oxide layer pattern was formed by etching an exposed silicon oxide layer through the polymer layer pattern. When an etching gas including a fluorocarbon gas was used in a dry-etching process for forming the silicon oxide layer pattern, the polymer layer pattern had a high etching selectivity with respect to the photoresist pattern. Thus, in a formation of the silicon oxide layer pattern, the polymer layer pattern was not removed completely so that damage to an upper portion of the silicon oxide layer pattern was prevented.

According to the present invention, a composition has an organic-inorganic hybrid system and is formed by a spin-coating process. Thus, a polymer layer formed using the composition of the present invention may have improved etching resistance with respect to a photoresist pattern in an etching process using an oxygen gas. In addition, the polymer layer formed using the composition of the present invention may have improved etching resistance with respect to the photoresist pattern in an etching process using an fluorocarbon gas. When a lower layer is patterned using the polymer layer as a mask, a damage of the lower layer may be prevented. Therefore, a defect generation of a semiconductor device may be prevented and a productivity of a semiconductor device manufacturing process may be enhanced.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of this invention as defined in the claims. In the claims, means-plus-function clauses are intended to cover the structures described herein as performing the recited function, and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A composition for forming a polymer layer comprising:
a polyhydroxystyrene resin;
a cross-linking compound including silicon; and
a solvent.

2. The composition of claim 1, wherein the polyhydroxystyrene resin has a weight average molecular weight of about 6,500 to about 9,500.

3. The composition of claim 1, wherein the cross-linking compound includes polyethyleneoxide linked with bis-trimethoxysilane.

4. The composition of claim 1, wherein the cross-linking compound is represented by the following formula (1): 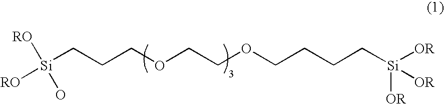
wherein R represents hydrogen or an alkyl group.

5. The composition of claim 1, wherein the composition includes about 10 to about 35 parts by weight of the cross-linking compound based on about 100 parts by weight of the polyhydroxystyrene resin.

6. The composition of claim 1, wherein the composition includes about 1 to about 6 percent by weight of the polyhydroxystyrene resin, about 0.1 to about 1.8 percent by weight of the cross-linking compound and a remainder of the solvent.

7. A method of forming a pattern comprising:
forming a polymer layer on an object by coating thereon a composition including a polyhydroxystyrene resin, a cross-linking compound including silicon and a solvent;
forming a photoresist pattern on the polymer layer;
forming a polymer layer pattern by etching an exposed polymer layer through the photoresist pattern; and
etching an exposed object using the polymer layer pattern as a mask.

8. The method of claim 7, wherein the polyhydroxystyrene resin has a weight average molecular weight of about 6,500 to about 9,500.

9. The method of claim 7, wherein the cross-linking compound includes polyethyleneoxide linked with bis-trimethoxysilane.

10. The method of claim 7, wherein the cross-linking compound is represented by the following formula (1): 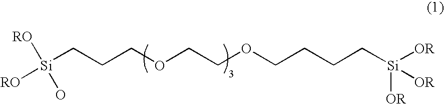
wherein R represents hydrogen or an alkyl group.

11. The method of claim 7, wherein the composition includes about 1 to about 6 percent by weight of the polyhydroxystyrene resin, about 0.1 to about 1.8 percent by weight of the cross-linking compound and a remainder of the solvent.

12. The method of claim 7, wherein the composition includes about 10 to about 35 parts by weight of the cross-linking compound based on about 100 parts by weight of the polyhydroxystyrene resin.

13. The method of claim 7, wherein the polymer layer is formed by a condensation reaction between the cross-linking compound and the polyhydroxystyrene resin.

14. The method of claim 13, wherein the polymer layer includes a compound represented by the following formula (2). 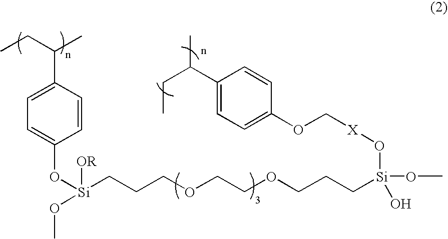
wherein R represents hydrogen or an alkyl group, X represents a chromophore and n represents an integer greater than or equal to 1.

15. The method of claim 7, wherein the polymer layer pattern is formed by an etching process using an etching gas including oxygen (O₂) gas.

16. The method of claim 7, wherein the object includes silicon oxide or silicon nitride.

17. The method of claim 7, further comprising removing a remaining photoresist pattern from the polymer layer pattern after etching the exposed object.

18. The method of claim 7, wherein the polymer layer is formed by a spin-coating process.
